(19) United States
(12) Patent Application Publication
(10) Pub. No.: US 2013/0288210 A1
(43) Pub. Date: Oct. 31, 2013

(54) INTEGRATED MAINTENANCE MANAGEMENT SYSTEM

(71) Applicants: Andrew James Stewart, Potterville, MI (US); Stephen Foster, Okemos, MI (US); Ghazi A. Saleem, Round Rock, TX (US); James H. Stewart, Holt, MI (US); Robert Stanley Koresky, Morrice, MI (US); William E. Puetz, Battle Creek, MI (US); Donald L. Reeves, II, Stockbridge, MI (US); Lawrence P. Crochet, Coppell, TX (US); Don Reynolds, Howell, MI (US); Eric G. Anderson, Edmond, OK (US)

(72) Inventors: Andrew James Stewart, Potterville, MI (US); Stephen Foster, Okemos, MI (US); Ghazi A. Saleem, Round Rock, TX (US); James H. Stewart, Holt, MI (US); Robert Stanley Koresky, Morrice, MI (US); William E. Puetz, Battle Creek, MI (US); Donald L. Reeves, II, Stockbridge, MI (US); Lawrence P. Crochet, Coppell, TX (US); Don Reynolds, Howell, MI (US); Eric G. Anderson, Edmond, OK (US)

(21) Appl. No.: 13/460,751

(22) Filed: Apr. 30, 2012

(51) Int. Cl. B23P 6/00; G09B 19/00

(52) U.S. Cl. 434/219; 29/402.01

(57) ABSTRACT

A semi-automated maintenance management system instructs a technician to disassemble a component into parts, compare each part to a reference entry and identify any discrepancies between the part and the reference entry, repair or replace the component according to instructions automatically provided for the discrepancy when a known discrepancy is found, create a disposition when an unknown discrepancy is found, and reassemble the component.

### TECHNICAL FIELD

The present disclosure is related to processes for component repair, and more particularly to an integrated maintenance management system for facilitating the repair and overhaul of a component.

### BACKGROUND OF THE INVENTION

Components, such as thrust reversers for aircraft, require regular repair and overhaul servicing to maintain a desired level of operability. A standard overhaul and repair operation requires the component to be disassembled, and each of the component's parts to be inspected and repaired or replaced as necessary. Existing processes for overhaul and repair maintenance require the integration of technical data from at least three sources, engine manuals, service bulletins, and proprietary repairs, to effect a repair and overhaul of a given component.

Each person involved in the repair and overhaul process must be trained to determine where to locate the information that is required to complete each task. As a result, engineers and designers are routinely required to answer questions and participate in the repair and overhaul of a component in order to maintain production. The frequent requirement that engineers and designers assist in the maintenance process increases the time required for maintenance, as well as increasing the costs associated with maintenance.

### SUMMARY OF THE INVENTION

Disclosed is a semi-automated method for performing maintenance having the steps of accessing a semi-automated maintenance system, wherein the semi-automated maintenance system includes a server storing a maintenance management system; disassembling a component into parts; comparing each of the parts to a reference entry in the maintenance management system and identifying any discrepancies between each of said parts and the reference entry; repairing or replacing each of the parts according to instructions provided by the maintenance management system when an identified discrepancy is included in the maintenance management system; creating a disposition in the maintenance management system when the identified discrepancy is not included in the maintenance management system; and reassembling the component according to instructions provided by the maintenance management system.

In a further embodiment of the above example, the step of creating a disposition in the maintenance management system when the identified discrepancy is not included in the maintenance management system further comprises the steps of the maintenance management system notifying an engineer of the identified discrepancy, the maintenance management system accepting a repair/replace solution from the engineer and storing the repair/replace solution from the engineer in the maintenance management system such that the identified discrepancy is added to a list of discrepancies, and repairing or replacing the part pursuant to instructions included in the maintenance management system.

In a further embodiment of the any of the above examples, the step of comparing each of the parts to a reference entry in a maintenance management system and identifying any discrepancies between each of the parts and the reference entry further has the maintenance management system automatically compiling a quote estimating repair costs for the component based on the identified discrepancies.

In a further embodiment of the any of the above examples, the step of comparing each of the parts to a reference entry in a maintenance management system and identifying any discrepancies between the part and the reference entry further includes photographing each of the identified discrepancies, uploading each of the photographed discrepancies to the maintenance management system, and including each of the photographed discrepancies in the automatically compiled quote.

In a further embodiment of the any of the above examples, the quote estimating maintenance costs for the components based on the identified discrepancies incorporates contract based repair estimates.

A further embodiment of any of the above examples includes the step of: reviewing the maintenance management system for any unperformed service bulletins related to each of the parts, and performing the unperformed service bulletins.

A further embodiment of any of the above examples includes the step of updating the maintenance management system with newly issued service bulletins by altering the instructions for a corresponding part to include the newly issued service bulletin.

A further embodiment of any of the above examples includes the step of: the maintenance management system tracking each iteration of the step of repairing or replacing each of the parts according to instructions provided by the maintenance management system when an identified discrepancy is included in the maintenance management system performed in a shift, and the maintenance management system compiling a list of materials required to be ordered based on the instructions provided by the maintenance management system, wherein the list is formatted such that a technician can automatically order any necessary materials from the shift using the list of materials.

In a further embodiment of any of the above examples, the maintenance management system automatically orders all of the necessary materials.

In a second non-limiting disclosed embodiment, a semi-automated maintenance system has a server with a tangible computer readable medium storing a maintenance management system and storing instructions for instructing a technician to perform the steps of disassembling a component into parts, comparing each of the part to a reference entry in the maintenance management system and identifying any discrepancies between each of the parts and the reference entry, repairing or replacing each of the parts according to instructions provided by the maintenance management system when an identified discrepancy is included in the maintenance management system, creating a disposition in the maintenance management system when the identified discrepancy is not included in the maintenance management system, and reassembling the component according to instructions provided by the maintenance management system.

In a further embodiment of any of the above examples, the step of comparing each of the parts to a reference entry in a maintenance management system and identifying any discrepancies between each of the parts and the reference entry further includes: the maintenance management system automatically compiling a quote estimating repair costs for the component based on the identified discrepancies.

In a further embodiment of any of the above examples, the step of comparing each of the parts to a reference entry in the maintenance management system and identifying any discrepancies between each of the parts and the reference entry further includes: photographing each of the identified discrepancies, uploading each of the photographed discrepancies to the server storing the maintenance management system, and including each of the photographed discrepancies in the automatically compiled quote.

In a further embodiment of any of the above examples, the automatically compiled quote estimates maintenance costs for the component based on each of the identified discrepancies and incorporates contract based repair estimates.

In a further embodiment of any of the above examples, the tangible computer readable media further stores instructions for instructing a technician to perform the step of: reviewing the maintenance management system for any unperformed service bulletins related to each part, and performing the unperformed service bulletins.

In a further embodiment of any of the above examples, the tangible computer readable media further stores instructions for instructing a technician to perform the step of updating the maintenance management system with newly issued service bulletins by altering the instructions for a corresponding part to include the newly issued service bulletin.

In a further embodiment of any of the above examples, the tangible computer readable media further stores instructions for causing the maintenance management system to perform the steps of: tracking each repair/replace requirement performed in a shift, and compiling a list of materials required to be ordered based on the instructions provided by the maintenance management system, wherein the list is formatted such that a technician can automatically order any necessary materials from the shift using the list of materials.

In a further embodiment of any of the above examples, the semi-automated maintenance system is operable to order all of the necessary materials.

In a further embodiment of any of the above examples, the step of creating a disposition in the maintenance management system when the identified discrepancy is not included in the maintenance management system further includes the steps of: the maintenance management system notifying an engineer of the identified discrepancy, the maintenance management system accepting a repair/replace solution from the engineer and storing the repair/replace solution from the engineer in the maintenance management system such that the identified discrepancy is added to a list of discrepancies, and providing instructions for implementing the repair/replace solution to a technician.

These and other features of the present invention can be best understood from the following specification and drawings, the following of which is a brief description.

### BRIEF DESCRIPTION OF THE DRAWINGS

FIG. 1 illustrates a flowchart of a sample process for effecting a repair and overhaul of a component using a maintenance management system.

FIG. 2 illustrates a flow chart detailing a sub-process for automatically generating a maintenance quote.

FIG. 3 illustrates a flow chart detailing a sub-for updating the process of FIG. 1.

FIG. 4 illustrates a flow chart detailing a sub-process for automatically ordering parts.

FIG. 5 illustrates an arrangement for implementing a maintenance management system.

### DETAILED DESCRIPTION

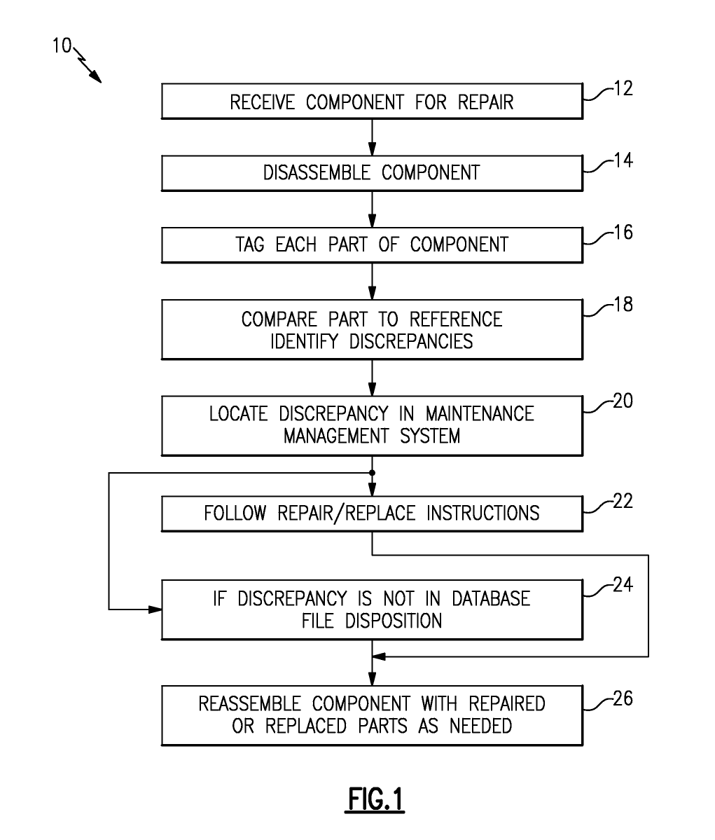

FIG. 1 illustrates a flowchart demonstrating a semi-automated process 10 for effecting maintenance of a component, such as a thrust reverser. Initially the component is received by the maintenance technicians in a “receive component for repair” step 12.

Once received, the component is disassembled into component parts in a “disassemble component” step 14. In order to properly disassemble the component into component parts, a technician consults a maintenance management system by accessing a semi-automated maintenance system. The maintenance management system is a computer program that includes step by step instructions detailing how to disassemble the component. As the component is being disassembled, each part is tagged with a unique identifier in a “tag each part of component” step 16. The tag can be printed from a computer terminal with access to the maintenance management system and can be affixed to the removed component part in any known fashion. Each tag includes unique identifying information for the part, and the unique identifying information is displayed in a compact form such as a bar code.

Once disassembled, each part is compared to a reference part file stored in the maintenance management system, and any discrepancies between the part and the reference part are identified in a “compare part to reference and identify discrepancies” step 18. A discrepancy is any way in which the part differs from the reference part. By way of non-limiting example, a crack or a gouge in the part that is not present in the reference part is a discrepancy.

Once all discrepancies in a particular part have been identified by the technician, the technician consults a list of known discrepancies in the maintenance management system in a “locate discrepancies in maintenance management system” step 20. The maintenance management system includes a list of all known discrepancies that can occur in the part. Once the technician selects the appropriate discrepancy (or discrepancies) from the list of discrepancies, the maintenance management system provides detailed instructions from how to repair the part if the discrepancy is reparable. If the discrepancy is irreparable, the maintenance management system indicates that the part must be replaced, and automatically adds a corresponding replacement part to a parts order form.

The technician then repairs or replaces the part according to instructions provided by the maintenance management system in a “follow repair/replace instructions” step 22.

In the case that an unknown discrepancy (i.e. a discrepancy that has not been previously encountered) is found, the technician creates a disposition in the maintenance management system in a “if discrepancy is not in database, create disposition” step 26. When a disposition is created, the maintenance management system notifies a higher level system user, such as an engineer or designer of the corresponding component part, that a disposition has been created, as well as the details of the particular discrepancy. The higher level user then determines if the component part is repairable or if the component part must be replaced, and how the component part should be repaired if it is repairable. The engineer or designer then updates the maintenance management system to add the newly identified discrepancy to the list of discrepancies, and to include the corresponding repair/replace instructions.

Once all the component parts have been identified and repaired or replaced as necessary, the technician reassembles the component according to instructions provided by the maintenance management system in a “reassemble component with repaired or replaced parts as needed” step 26. Since each part was uniquely tagged in the “tag each part of component” step 16, the technician can ensure that each of the repaired parts and each of the original parts having no discrepancies is included in the corresponding original component. As an additional benefit, the maintenance management system tracks previous repairs and replacements of the component and can provide the technical with a complete maintenance history of any component or part as needed.

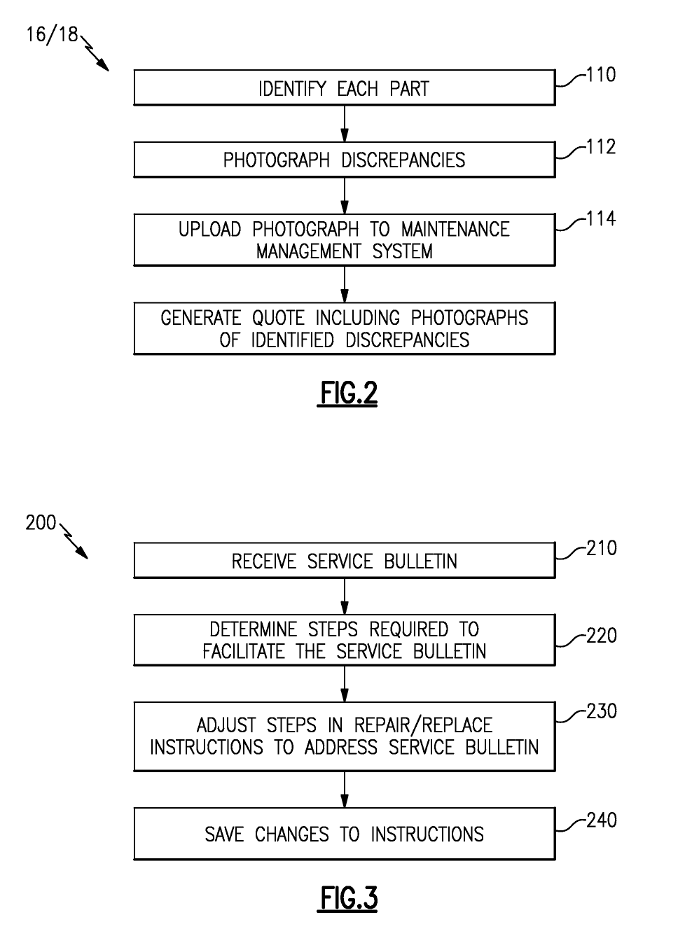

In some example embodiments, the maintenance management system can additionally generate a maintenance quote that can be provided to a client as part of the “tag each component part” step 16 and the “compare part to reference and identify any discrepancies” step 18. FIG. 2 illustrates a flowchart showing how the “compare part to reference and identify discrepancies” step 18 is altered to automatically generate a quote estimating the costs for the maintenance of the component.

During the “compare part to reference and identify discrepancies” step 18, the technician identifies the part using the unique tag identifier in an “identify each part” step 110. Once each part has been identified, the technician photographs any discrepancies found in the “compare part to reference and identify discrepancies” step 18 in a “photograph discrepancies” step 112. Each of the photographs is uploaded to the maintenance management system along with a description of the identified discrepancy in an “upload photograph to maintenance management system” step 114. The maintenance management system then generates a quote indicating an estimated cost to repair each identified discrepancy based on a saved estimated repair cost for the discrepancy. The saved estimated repair cost is saved in the maintenance management system. Furthermore, the generated quote includes a photograph of each identified discrepancy. The generated quote can be a .pdf document, an Excel spreadsheet, a text document, or any other desired computer format. By including a photograph of the discrepancy in the automatically generated quote, more information is provided to the client, and a more accurate representation of the repairs required is illustrated.

In some embodiments the maintenance management system can be updated to include service bulletins that indicate required maintenance or tests on certain parts. FIG. 3 illustrates an example process by which an engineer or designer who receives a service bulletin can update the maintenance management system to include information provided by the service bulletin. Initially, the engineer or designer receives the service bulletin from the manufacturer of the part, or from any other source of service bulletins in a “receive service bulletin” step 210. The engineer or designer who received the service bulletin reviews the service bulletin and determines what maintenance steps are necessary to perform the service bulletin and when the service bulletin must be performed in a “determine steps required to facilitate the service bulletin” step 220.

Once the necessary steps are determined, the engineer or designer can log into the maintenance management system as a higher level user than a technician and manually edit the repair/replace instructions for the part or parts related to the service bulletin in an “adjust steps in repair/replace instructions to address service bulletin” step 230. The new repair/replace instructions instruct any technician consulting the maintenance management system in how to perform the service bulletin, as well as how to perform any required repairs based on a selected discrepancy. Once the engineer or technician has entered the service bulletin information into the maintenance management system, the engineer or technician saves the changes in a “save changes to instructions” step 240 thereby “locking in” in the change to the instructions. The new instructions incorporating the service bulletin are propagated through the maintenance management system immediately, thereby reducing a lag time between receipt of a service bulletin, and implementation of the service bulletin.

Engineers and designers log in to the maintenance management system using a high permissions level login, whereas technicians log in to the maintenance management system using a lower permissions level login, thus the technicians cannot alter the entries within the system, whereas the engineers and designers can.

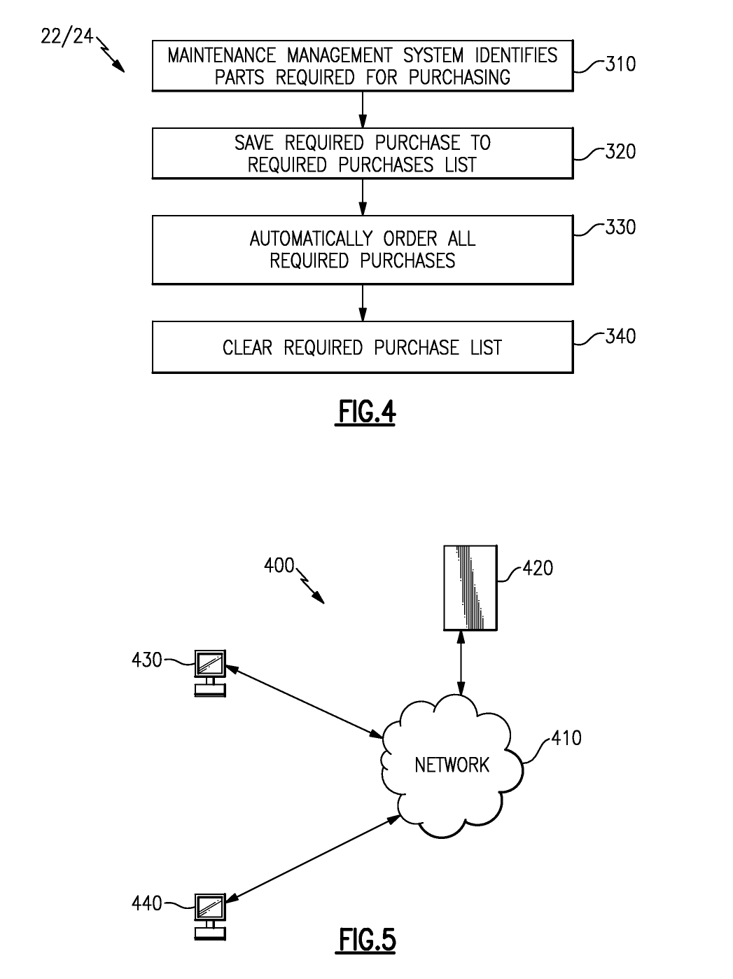

In further examples, the maintenance management system can identify required parts and materials that must be purchased to implement the “follow repair/replace instructions” step 22 from FIG. 1. A flowchart illustrating the process for identifying the materials is illustrated in FIG. 4. Initially, whenever a technician identifies a discrepancy that cannot be repaired, the maintenance management system identifies that a replacement part must be ordered in a “maintenance management system identifies parts required for purchasing” step 310. Likewise, if a particular material is required to implement necessary repairs, the material is identified.

Each of the identified parts or materials is saved to a required purchases list in a “save required purchases to required purchases list” step 320. The required purchases list can be a database of required parts to be ordered including a supplier from which the required part is ordered. Alternately the required purchases list can be multiple databases, with each database corresponding to a specific supplier.

At the end of each shift, or at any other designated time, the maintenance management system automatically orders all parts on the required purchases list in an “automatically order all required purchases” step 330. The automatic ordering can be achieved either by the maintenance management system directly connecting to an ordering system and placing the order, or by presenting an operator (such as a technician) with a generated order form that the operator then copies into a parts ordering system.

FIG. 5 illustrates a physical arrangement 400 for implementing the maintenance management system described above. The maintenance management system is stored on a remote server 420 and is accessed by engineers, designers and technicians through a network 410 such as the internet. The engineers, designers and technicians access the maintenance management system using personal computers 430, 440 through a web interface such as a website. Maintenance management system databases, such as parts ordering database or a repair instructions database can be hosted on the server 420 in some implementations, or alternatively, the databases can be stored locally at the personal computers 430, 440. In alternate implementations, the server 420 can be a local server, and the network 410 can be a local area network.

Although an example embodiment of this invention has been disclosed, a worker of ordinary skill in this art would recognize that certain modifications would come within the scope of this invention. For that reason, the following claims should be studied to determine the true scope and content of this invention.

1. A semi-automated method for performing maintenance comprising the steps of:
accessing a semi-automated maintenance system, wherein the semi-automated maintenance system includes a server storing a maintenance management system;
disassembling a component into parts;
comparing each of said parts to a reference entry in said maintenance management system and identifying any discrepancies between each of said parts and said reference entry;
repairing or replacing each of said parts according to instructions provided by said maintenance management system when an identified discrepancy is included in said maintenance management system;
creating a disposition in said maintenance management system when said identified discrepancy is not included in said maintenance management system; and
reassembling said component according to instructions provided by said maintenance management system.

2. The method of claim 1, wherein said step of creating a disposition in said maintenance management system when said identified discrepancy is not included in said maintenance management system further comprises the steps of:
said maintenance management system notifying an engineer of said identified discrepancy;
said maintenance management system accepting a repair/replace solution from said engineer and storing said repair/replace solution from said engineer in said maintenance management system such that said identified discrepancy is added to a list of discrepancies; and
repairing or replacing said part pursuant to instructions included in said maintenance management system.

3. The method of claim 1, wherein said step of comparing each of said parts to a reference entry in a maintenance management system and identifying any discrepancies between each of said parts and said reference entry further comprises:
said maintenance management system automatically compiling a quote estimating repair costs for said component based on said identified discrepancies.

4. The method of claim 3, wherein said step of comparing each of said parts to a reference entry in a maintenance management system and identifying any discrepancies between said part and said reference entry further comprises:
photographing each of said identified discrepancies;
uploading each of said photographed discrepancies to said maintenance management system; and
including each of said photographed discrepancies in said automatically compiled quote.

5. The method of claim 3, wherein said quote estimating maintenance costs for said components based on said identified discrepancies incorporates contract based repair estimates.

6. The method of claim 1, further comprising the step of:
reviewing said maintenance management system for any unperformed service bulletins related to each of said parts, and performing said unperformed service bulletins.

7. The method of claim 1, further comprising the step of updating the maintenance management system with newly issued service bulletins by altering said instructions for a corresponding part to include said newly issued service bulletin.

8. The method of claim 1 further comprising the step of:
said maintenance management system tracking each iteration of the step of repairing or replacing each of said parts according to instructions provided by said maintenance management system when an identified discrepancy is included in said maintenance management system performed in a shift; and
said maintenance management system compiling a list of materials required to be ordered based on said instructions provided by said maintenance management system, wherein said list is formatted such that a technician can automatically order any necessary materials from said shift using said list of materials.

9. The method of claim 8, wherein said maintenance management system automatically orders all of said necessary materials.

10. A semi-automated maintenance system comprising;
a server having a tangible computer readable medium storing a maintenance management system and storing instructions for instructing a technician to perform the steps of
disassembling a component into parts;
comparing each of said part to a reference entry in said maintenance management system and identifying any discrepancies between each of said parts and said reference entry;
repairing or replacing each of said parts according to instructions provided by said maintenance management system when an identified discrepancy is included in said maintenance management system;
creating a disposition in said maintenance management system when said identified discrepancy is not included in said maintenance management system; and
reassembling said component according to instructions provided by said maintenance management system.

11. The semi-automated maintenance system of claim 10, wherein said step of comparing each of said parts to a reference entry in a maintenance management system and identifying any discrepancies between each of said parts and said reference entry further comprises:
said maintenance management system automatically compiling a quote estimating repair costs for said component based on said identified discrepancies.

12. The semi-automated maintenance system of claim 11, wherein said step of comparing each of said parts to a reference entry in said maintenance management system and identifying any discrepancies between each of said parts and said reference entry further comprises:
photographing each of said identified discrepancies;
uploading each of said photographed discrepancies to said server storing said maintenance management system; and
including each of said photographed discrepancies in said automatically compiled quote.

13. The semi-automated maintenance system of claim 12, wherein said automatically compiled quote estimates maintenance costs for said component based on each of said identified discrepancies and incorporates contract based repair estimates.

14. The semi-automated maintenance system of claim 10, wherein the tangible computer readable media further stores instructions for instructing a technician to perform the step of:
reviewing said maintenance management system for any unperformed service bulletins related to each part, and performing said unperformed service bulletins.

15. The semi-automated maintenance system of claim 10, wherein the tangible computer readable media further stores instructions for instructing a technician to perform the step of updating the maintenance management system with newly issued service bulletins by altering said instructions for a corresponding part to include said newly issued service bulletin.

16. The semi-automated maintenance system of claim 10, wherein the tangible computer readable media further stores instructions for causing the maintenance management system to perform the steps of:
tracking each repair/replace requirement performed in a shift; and
compiling a list of materials required to be ordered based on said instructions provided by said maintenance management system, wherein said list is formatted such that a technician can automatically order any necessary materials from said shift using said list of materials.

17. The semi-automated maintenance system of claim 16, wherein said semi-automated maintenance system is operable to order all of said necessary materials.

18. The semi-automated maintenance system of claim 10, wherein said step of creating a disposition in said maintenance management system when said identified discrepancy is not included in said maintenance management system further comprises the steps of:
said maintenance management system notifying an engineer of said identified discrepancy;
said maintenance management system accepting a repair/replace solution from said engineer and storing said repair/replace solution from said engineer in said maintenance management system such that said identified discrepancy is added to a list of discrepancies; and
providing instructions for implementing said repair/replace solution to a technician.
